(19) United States
(12) Patent Application Publication
(10) Pub. No.: US 2013/0199344 A1
(43) Pub. Date: Aug. 8, 2013

(54) ELECTRIC WRENCH

(71) Applicant: Sunheng Technology Co., Ltd., Taichung City (TW)

(72) Inventor: Barry LEE, Taichung City (TW)

(73) Assignee: Sunheng Technology Co., Ltd., Taichung City (TW)

(21) Appl. No.: 13/756,514

(22) Filed: Jan. 31, 2013

(30) Foreign Application Priority Data
Feb. 3, 2012 (TW) 101201953

(51) Int. Cl. B25B 23/142

(52) U.S. Cl. CPC B25B 23/1425
USPC 81/467

(57) ABSTRACT

An electric wrench which includes a main body, a control unit, a torque sensor, a vibrating module and a phonetic module is provided. The main body includes a handle extend to form a holding portion. The vibrating module which includes a shell body and a vibration motor is mounted to the holding portion. The shell body includes a first end adjacent to one of the handle, and a second end. The first end defines a motor receiving space, and the vibration motor is disposed in the motor receiving space and electrically connected to the control unit. Whereby, the wrench is light-weight and friendly and comfortable for holding, and the vibration can be sensed by hand, and may produce, for example, human sound. Furthermore, the vibration and the human sound may be produced at the same time.

### BACKGROUND OF THE INVENTION

1. Field of the Invention

The present invention relates to a wrench, more particularly, to an electric wrench.

2. Description of the Prior Art

A fastener requiring specific and accurate driving torque generally requires a torque wrench to drive it to fix to an object. A conventional torque wrench can produce vibration to alert the user when the output torque value of a working portion of the torque wrench reaches to the predetermined torque value. The torque wrench includes a vibration device having a post-shaped vibration motor and an eccentric weight block. The eccentric weight block is disposed at one end of the post-shaped vibration motor, and a magnet is disposed in the interior of the post-shaped vibration motor. When the magnet is applied with an electric power to drive a spindle rotating, the spindle drives the eccentric weight block rotating to produce vibration.

However, the vibration device has a large size and is very heavy, and the handle has a greater dimension, so that it is inconvenient and laborious to hold the handle by hand, and can affect the operation of the wrench. Furthermore, the eccentric weight block increases the burden on the spindle of the vibration motor, such that the spindle cannot rotate fast and the frequency and magnitude of vibration is insufficiently low. Additionally, since the vibration device is disposed at the distal end of the handle and the vibration direction of the vibration device is parallel to the longitudinal direction of the handle, the vibration is majorly transmitted from the distal end of the handle and radially gradually disperses along the longitudinal direction of the handle. As a result, less of the vibration is transmitted in width direction of the handle, and thus the user can hardly feel the vibration, so that the alert effect is not good.

As above, since the vibration device is disposed at the distal end of the handle, the opening of the battery receiving space has to be formed on a lateral side of the handle. As such, when the battery has to be changed, the sheath has to be removed from the handle in advance, and thus it is very inconvenient. The present invention is, therefore, arisen to obviate or at least mitigate the above mentioned disadvantages.

### SUMMARY OF THE INVENTION

An object of the present invention is to provide an electric wrench which is light-weight. Besides, the vibration can be evenly transmitted, and an alert signal may be provided, for example, via human sound.

To achieve the above and other objects, an electric wrench includes a main body, a control unit, a torque sensor, a vibrating module and a phonetic module. The main body includes a working portion and a handle, the working portion is disposed at one end of the handle, and the other end of the handle extends to form a holding portion. The control unit is mounted to the main body and set with a predetermined torque value. The torque sensor is mounted to the main body and electrically connected to the control unit, and the torque sensor is for sensing an output torque value of the working portion and transmitting a sensing signal to the control unit. The vibrating module is mounted to the holding portion, the vibrating module includes a shell body and a vibration motor, the shell body includes a first end and a second end, the first end of the shell body is adjacent to the other end of the handle, the shell body defines a motor receiving space located at the first end of the shell body, and the vibration motor is disposed in the motor receiving space and electrically connected to the control unit. The vibration motor is a hidden-type eccentric load vibration motor and substantially plate-shaped. The phonetic module is mounted to the main body, electrically connected to the control unit and including a speaker. When the output torque value of the working portion reaches to the predetermined torque value, the control unit drives the vibrating module vibrating, and drives the phonetic module generating an alert signal which is broadcasted via the speaker.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view according to a preferred embodiment of the present invention;

FIG. 2 is a breakdown drawing of a vibrating module according to a preferred embodiment of the present invention;

FIG. 3 is a assembly drawing of a vibrating module according to a preferred embodiment of the present invention; and

FIG. 4 is a view showing a vibrating module according to an alternative embodiment of the present invention.

### DETAILED DESCRIPTION OF THE PREFERRED EMBODIMENTS

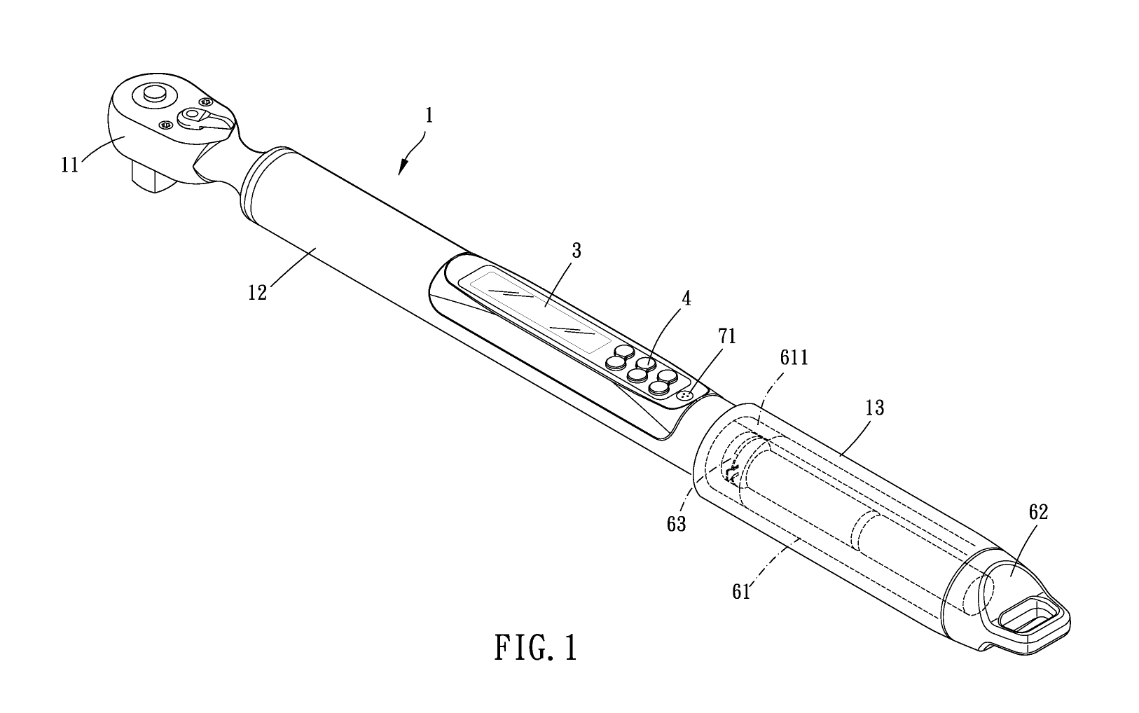

As shown in FIGS. 1 to 3, an electric wrench according to a preferred embodiment of the present invention includes a main body 1, a control unit, a display screen 3, an operation assembly 4, a torque sensor, a vibrating module 6 and a phonetic module.

The main body 1 includes a working portion 11 and a handle 12, and the working portion 11 is disposed at one end of the handle 12. The main body 1 may be any kind of electric wrench which is capable of electric torque-detecting, such as a ratchet wrench, adjustable wrench or the like, and the type of the working portion 11 is determined correspondingly according to the type of the main body. However, no matter what type of electric wrench the main body is, the working portion 11 is majorly for driving a fastener such as nut, screw or the like (not shown) so that the fastener fastened to or unfastened from an object or the object. The other end of the handle 12 extends to form a holding portion 13. Preferably, a sheath is surrounded around the holding portion.

The control unit is mounted to the main body 1. Preferably, the control unit is mounted to the handle 12. The control unit is set with a predetermined torque value. The display screen 3 is disposed on the handle 12 and electrically connected to the control unit. The display screen 3 is for displaying a torque value. The operation assembly 4 is disposed on the handle 12 and electrically connected to the control unit. The operation assembly 4 includes plural buttons adapted for adjusting predetermined torque value by an user.

The torque sensor (not shown) is mounted to the main body 1 and electrically connected to the control unit. Preferably, the torque sensor is disposed on the handle 12 and adjacent to the working portion 11. The torque sensor is, in this embodiment, a strain gauge for sensing an output torque of the working portion 11 on the fastener, and the torque sensor then transmits a sensing signal to the control unit. Generally speaking, the sensing signal corresponds to a voltage variation signal generated due to the strain of the strain gauge. The voltage variation signal is numeralized by the control unit to be a torque value which can be displayed on the display screen 3.

The vibrating module 6 is mounted to the holding portion 13, and the vibrating module 6 includes a shell body 61, a cover 62 and a vibration motor 63.

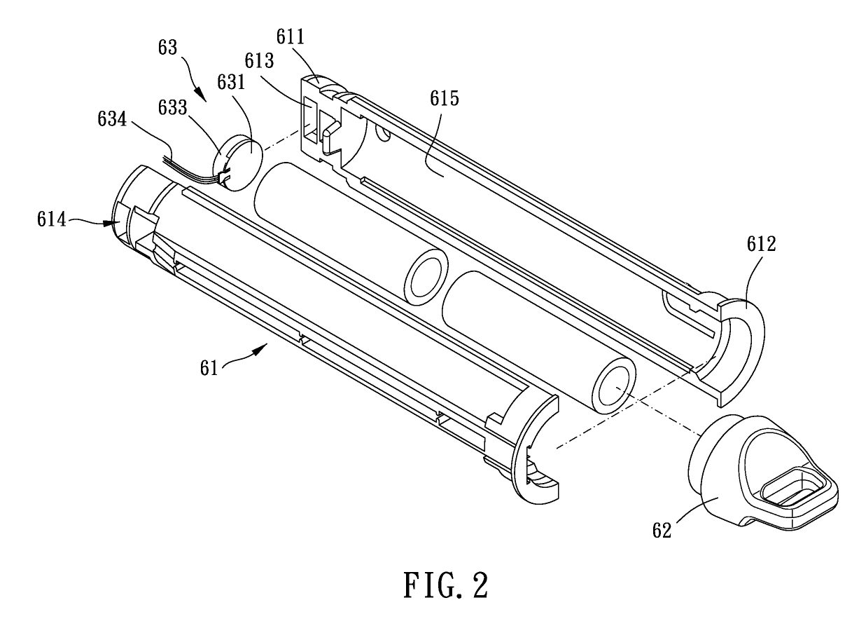

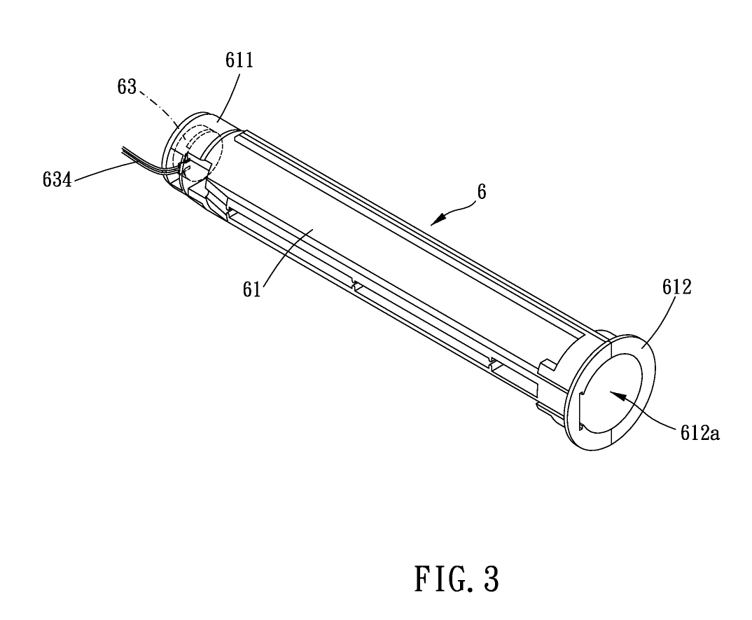

The shell body 61 includes a first end 611 and a second end 612. The first end 611 of the shell body is adjacent to the other end of the handle 12 (as shown in FIG. 1), and the second end 612 of the shell body is formed with an opening 612a, In this embodiment, the shell body 61 is disposed in the holding portion 13, and the shell body 61 is tubular. A longitudinal direction of the shell body 61 is parallel to a longitudinal direction of the holding portion 13. The shell body 61 defines a motor receiving space 613, a through hole 614 and a battery receiving space 615. The motor receiving space 613 is disposed at the first end 611 of the shell body (as shown in FIGS. 2 and 3), the through hole 614 is communicated with the motor receiving space 613. Preferably, an axial direction of the motor receiving space 613 is parallel to the longitudinal direction of the holding portion 13, and an axial extent of the motor receiving space 613 is less than a radial extent of the motor receiving space 613. The motor receiving space 613 has a geometric recess, preferably a circular recess. The battery receiving space 615 is located between the motor receiving space 613 and the opening 612a, and the battery receiving space 615 and the opening 612a are communicated with each other. The cover 62 is for covering the opening 612a. One end of the battery receiving space 615 is formed with a first terminal (not shown), the cover 62 is formed with a second terminal (not shown), and the battery receiving space 615 is adapted for receiving a battery. When the cover 62 covers the opening 612a, the positive and negative electrodes of the battery electrically contact the first and second terminals respectively, so that the electric power can be applied to the control unit and other parts, which require electric power to function, of the electric wrench.

The vibration motor 63 is disposed in the motor receiving space 613, and the vibration motor 63 included a base 631, an eccentric rotor (not shown), an outer cover 633 and a wire 634. The base 631 is provided with a magnet therein. The eccentric rotor is rotatably mounted on the base 631 and provided with coils. The outer cover 633 covers the base 631, and the wire 634 is disposed through the through hole 614 and electrically connected to the control unit. The vibration motor 63 is configured to form a hidden-type eccentric load vibration motor. Preferably, the vibration motor 63 is substantially plate-shaped, preferably a plate disc. The axial extent of the motor receiving space 613 and an axial thickness of the vibration motor 63 are substantially equal, and a radial extent of the motor receiving space 613 and the radial extent of the vibration motor 63 are substantially equal. In other words, two opposing flat surfaces of the vibration motor 63 correspond to two axial side walls of the motor receiving space 613 respectively, and a smooth surface of the vibration motor 63 corresponds to a radial arcuate side wall of the motor receiving space 613. As such, the outer contour of the vibration motor 63 matches the inner contour of the motor receiving space 613. When the eccentric rotor rotates eccentrically relative to the base 633 about an axis so as to produce vibration, the movement of the vibration of the vibration motor 63 is of a direction which is perpendicular to a longitudinal direction of the holding portion 13. The vibration motor 63 impacts the radial arcuate side wall of the motor receiving space 613, so that the vibration is transmitted evenly to the entire holding portion 13 via the first end 611 of the shell body.

The phonetic module is mounted to the main body 1 and electrically connected to the control unit. Preferably, the phonetic module includes a speaker 71 disposed on the handle 12, and the phonetic module can broadcast an alert signal such as human sound or music to inform the user. Preferably, the phonetic module further includes a setting unit through which a predetermined alert character string and user-set alert character string can be selectively set, whereby the user can choose the predetermined alert signal or set an alert signal corresponding to the user-set alert character string. The aforementioned alert signal is preferably in a form of an alert character string. Additionally, the phonetic module may include kinds of language models to be chosen by the user.

When the output torque value of the working portion 11 reaches to the predetermined torque value, the control unit drives the vibrating module 6 vibrating and drives the phonetic module broadcasting the alert signal via the speaker 71 in the form of human sound or humming an alert character string or playing some of music.

The alert character string such as “the output torque value has reached to the predetermined torque value, please stop operation”; the music may be one song or simple sound such as “beep” or “buzz” or “ clank or clang”. As such, the user can feel the vibration via his hand and hear the sounded alert character string, so that the user is informed of that the fastener is sufficiently fastened, and the user should stop rotating the fastener.

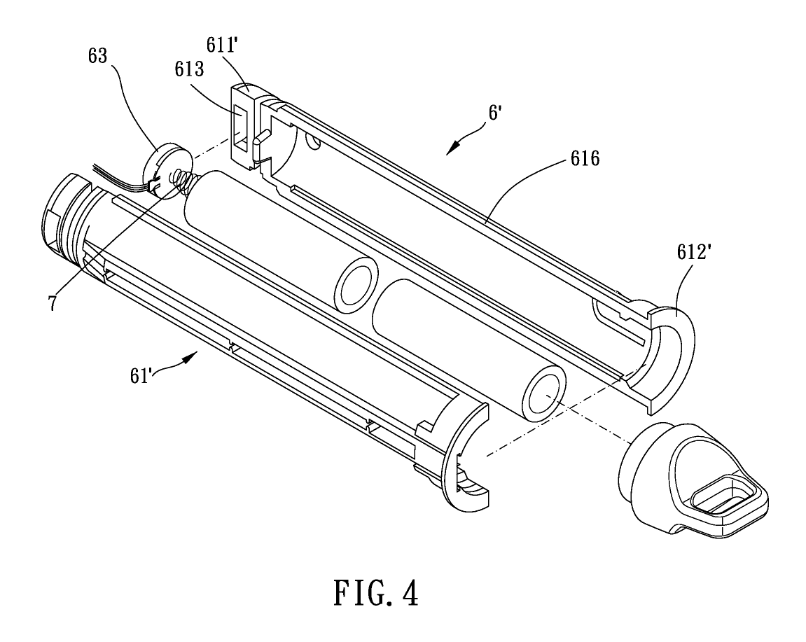

As shown in FIG. 4, in an alternative embodiment, a shell body 61′ of a vibrating module 6′ may includes separate first end 611′ having a motor receiving space 613 and main portion 616 provided with the second end 612′. The vibration motor 63 is preferably tightly received in the first end 611′ without gaps. The first end 611′ is tightly attached to and in the holding portion. An elastic electrical conductive member 7 such as a metal spring, but is not limited thereto, is disposed between and electrically connects the vibration motor 63 and the battery, so that the vibration motor 63 and the battery are electrically connected and separated apart from each other, and the main portion 616 and the first end 611′ are also separated apart from each other. Preferably, the small the contact area of the elastic electrical conductive member 7 and the vibration motor 63 is, the better the vibration effect is. Since the vibration motor 63 is tightly received in the first end 611′ tightly attached to and in the holding portion and the main portion 616 and the first end 611′ are separated apart from each other, the vibration can be mostly sufficiently transferred to the holding portion so as to provide a better vibration effect.

Given the above, the hidden-type eccentric load vibration motor 63 is small and light-weight, and requires no weight member, so that the holding portion 13 can be made with a small size and the main body 1 can have a light weight. Whereby, the electric wrench is friendly and comfortable for holding and causes a low burden on the hand of the user.

Furthermore, the hidden-type eccentric load vibration motor 63 can generate preferable vibration effect, the vibration motor 63 is located close to the mid portion of the main body 1, and the outer counter of the vibration motor 63 is preferably completely matched with and attached to the inner counter of the motor receiving space 613. Since the movement of the vibration of the vibration motor 63 is of the direction which is perpendicular to the longitudinal direction of the holding portion 13, most percentage of the vibration motor 63 can be transmitted evenly to the holding portion 13 in a width direction of the holding portion 13. Hence, the hand of the user can distinctly feel the vibration, thus obtaining an excellent alert effect through vibration.

In an alternative embodiment, only the condition that the radial extent of the motor receiving space 613 and the radial extent of the vibration motor 63 are substantially equal is met, and the axial extent of the motor receiving space 613 is greater than the axial thickness of the vibration motor 63. In this instance, it can also obtain an excellent alert effect through vibration.

Additionally, for some users having lower hand sensibility and being not sensitive to vibration, the electric wrench is provided with the phonetic module which can broadcast so that the users can hear the sounded alert character string and can stop driving the electric wrench immediately, accordingly.

It is noted that the phonetic module may include kinds of language models for persons who speak in different language, the user can selectively choose one language model to be expressed.

The motor receiving space 613 is located at the first end 611 of the shell body, i.e., the shell body 61 is close to a distal end of the handle 12, so that the opening 612 can be formed at the second end 612 of the shell body 61. That is, the shell body 61 is close to a distal end of the holding portion 13, so that it needs to simply remove the cover 62 and put the battery into the battery receiving space 615 from the second end 612 of the shell body when the battery needs to be changed. Whereby, the battery can be changed conveniently and rapidly without removing the sheath.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electric wrench, including:
a main body, including a working portion and a handle, the working portion disposed at one end of the handle, the other end of the handle extending to form a holding portion;
a control unit, mounted to the main body and set with a predetermined torque value;
a torque sensor, mounted to the main body and electrically connected to the control unit, the torque sensor for sensing an output torque value of the working portion and transmitting a sensing signal to the control unit;
a vibrating module, mounted to the holding portion, the vibrating module including a shell body and a vibration motor, the shell body including a first end and a second end, the first end of the shell body being adjacent to the other end of the handle, the shell body defining a motor receiving space located at the first end of the shell body, the vibration motor disposed in the motor receiving space and electrically connected to the control unit;
wherein the vibration motor is a hidden-type eccentric load vibration motor and substantially plate-shaped;
a phonetic module, mounted to the main body, electrically connected to the control unit and including a speaker;
wherein when the output torque value of the working portion reaches to the predetermined torque value, the control unit drives the vibrating module vibrating and drives the phonetic module generating an alert signal which is broadcasted via the speaker.

2. The electric wrench of claim 1, wherein an axial direction of the motor receiving space is parallel to a longitudinal direction of the holding portion, an axial extent of the motor receiving space is less than a radial extent of the motor receiving space, and the movement of the vibration of the vibration motor is of a direction which is perpendicular to the longitudinal direction of the holding portion.

3. The electric wrench of claim 2, wherein the axial extent of the motor receiving space and an axial thickness of the vibration motor are substantially equal.

4. The electric wrench of claim 2, wherein a radial extent of the motor receiving space and the radial extent of the vibration motor are substantially equal.

5. The electric wrench of claim 3, wherein a radial extent of the motor receiving space and the radial extent of the vibration motor are substantially equal.

6. The electric wrench of claim 4, wherein the vibration motor is disc-shaped, and the motor receiving space is a circular recess.

7. The electric wrench of claim 5, wherein the vibration motor is disc-shaped, and the motor receiving space is a circular recess.

8. The electric wrench of claim 1, wherein the shell body is formed with a through hole communicated with the motor receiving space, and the vibration motor includes a wire disposed through the through hole and electrically connected to the control unit.

9. The electric wrench of claim 1, wherein the vibrating module includes a cover, the second end of the shell body is formed with an opening, the shell body defines a battery receiving space between the motor receiving space and the opening, the battery receiving space is communicated with the opening, and the cover covers the opening

10. The electric wrench of claim 1, wherein the phonetic module includes kinds of language models.

11. The electric wrench of claim 1, wherein the phonetic module includes a setting unit including a predetermined alert signal.

12. The electric wrench of claim 1, wherein the phonetic module includes a setting unit enabling to set the alert signal.

13. The electric wrench of claim 1, wherein the shell body further includes a main portion provided with the second end, the first end is separate from the main portion and has the motor receiving space, and the first end is tightly attached to the holding portion.

14. The electric wrench of claim 13, wherein an elastic electrical conductive member is disposed between and electrically connects the vibration motor and a battery received in the main portion, and the vibration motor and the battery are separated apart from each other by the elastic electrical conductive member.
